(19) United States
(12) Patent Application Publication
(10) Pub. No.: US 2020/0390029 A1
(43) Pub. Date: Dec. 17, 2020

(54) PORTABLE, REMOTE CONTROL, ZERO TURN, ELECTRIC, DIRECT DRIVE, LAWN MOWER

(71) Applicant: Edward Ruberton, Eustis, FL (US)

(72) Inventor: Edward Ruberton, Eustis, FL (US)

(21) Appl. No.: 16/712,227

(22) Filed: Dec. 12, 2019

Related U.S. Application Data
(60) Provisional application No. 62/780,324, filed on Dec. 16, 2018.

(51) Int. Cl. A01D 34/00; A01D 34/74; G05D 1/00

(52) U.S. Cl. CPC A01D 34/008; A01D 34/74; G05D 2201/0208; G05D 1/0038; G05D 1/0016

(57) ABSTRACT

A portable, remote control, zero turn, electric, direct drive, lawn mower (aka. R/C mower) includes a main body, a remote-control (R/C) transmitter, an electronics enclosure, two rear motor apparatuses, one or two front caster wheels, a cutting deck, one or more rotating electric motors, one or more grass cutting blades, one or more rechargeable batteries, one or more motor controllers, a microprocessor and software control system on the R/C transmitter, a set of command signals, a camera with video display, and a process wherein a loss of radio wave signal between the remote-control transmitter and receiver apparatus cuts off power to the R/C mower. This lawn mower is a safe, efficient, and easy way to cut the lawn. It frees a person from the drudgery of mowing grass and can actually make it a pleasurable experience.

### CROSS-REFERENCE TO RELATED APPLICATIONS

The present application claims priority to U.S. provisional patent application Ser. No. 62/780,324, filed on 16 Dec. 2018. The entire disclosure is included herein in its entirety at least by reference.

### FIELD OF INVENTION

The invention relates to power operated lawn mowers equipped for remote control (R/C). An R/C lawn mower frees a person from having to walk behind and push, or sit on top and steer a lawn mower. The mower can be operated from a simple, hand-held device while standing or sitting in a remote location. This is not only beneficial to the elderly and people with disabilities, but also for anyone who mows grass. The drudgery of the job is taken away and even can be fun. There is also the added safety of not having to be near the mower blades when the machine is in operation.

### BACKGROUND

Lawn mowers take many forms for different purposes. There are large commercial types typically consisting of a tractor pulling a deck of cutting blades down to smaller size mowers that consist of a small tractor with a cutting deck beneath. These mowers usually have powerful gasoline engines to get the job done quickly. They usually have a person riding on the machine to control it.

Then there are the residential lawn mowers which range from the small commercial sized ride-on mowers, to small, push-mowers. These mowers are usually gas-powered also. These mowers allow the operator to get the job done in a reasonable amount of time. But these gas mowers have a problem. They are very loud, they are dangerous for the operator and bystanders, they are expensive to buy, they are heavy and difficult to manage, they may require physical labor, and they emit large amounts of air pollution. In fact, according to the EPA, one new gas mower emits the same amount of air pollution as 11 new gas cars.

Electric mowers eliminate some of the problems of the gas-powered mowers. The are more quiet, they may be more affordable, and they do not pollute the air. But electric push-mowers are still dangerous, they are difficult to manage (especially those without batteries that require dragging a power cord all over the yard), and they require physical labor. These mowers are also still rather large and heavy (>50 lbs).

Now the robotic residential mowers are appearing. They are all-electric, battery powered machines that require no operator. Most of the problems of gas mowers stated above are eliminated with these new robotic mowers, except for the price. They are quite expensive for their size. But they have their own problems. The current robotic mowers cut a very narrow strip of grass and take hours or days to get the job done. They are relatively small and low powered compared to their predecessors. Also, they don't do a very good job because of the random pattern of mowing that looks uneven compared to the clean lines cut by a riding mower or push-mower. The worst part is that the robotic mowers cannot yet do the edging of the yard, which leaves the yard looking like an unfinished mess. This part needs to be done manually, and so partially defeating the purpose of the automatic robotic mower. And finally there is the problem of leaving a $1000-$3000 machine out in the yard all night. The manufacturers are incorporating various theft deterrents, from alarms to GPS, but the risk is there and it is something else to worry about. What is needed is a better solution to get the job of cutting grass done quickly and easily.

### SUMMARY OF THE INVENTION

In one embodiment of the invention a portable, remote control, zero turn, electric, direct drive, lawn mower (aka. R/C mower) is provided, comprising a cutting deck as part of the main body for attaching and enclosing the cutting blades and also providing the main supporting structure for the R/C mower, and an electronics enclosure as part of the main body and attached to the cutting deck containing all microprocessors and communications devices required and also providing the additional supporting structure for the R/C mower, a hand-held, remote-control transmitter that sends a set of command signals to a receiver apparatus on the R/C mower, a handle attached to the rear of the main body of the R/C mower to allow easy carrying, a right rear motor apparatus rigidly attached to the main body for propelling the right rear wheel through the use of a rotatable shaft from the rear right motor to the wheel, a left rear motor apparatus rigidly attached to the main body for propelling the left rear wheel through the use of a rotatable shaft from the left wheel motor to the wheel, a right front mounted free swiveling caster wheel apparatus rotatably attached to the body, a left front mounted free swiveling caster wheel apparatus rotatably attached to the body, one or more rotating electric motors firmly or adjustably mounted to a cutting deck, each of one or more grass cutting blades connected to a rotating drive shaft of one of a rotating motor, one or more rechargeable batteries for storing the electric power and driving the motors, one or more battery mounting plates firmly attached to the R/C mower main body, a main power switch incorporating a lighted element indicating when lit, that the R/C mower is on, one dual-motor controller to regulate the amount of current flowing to the left wheel motor and right wheel motor, a separate motor controller to regulate the amount of current flowing to the blade motors, a microprocessor and software control system on the transmitter that wirelessly send the set of command signals to the receiver which processes the signals and sends appropriate commands to the motor controllers, which then send electric power to the right rear motor apparatus and the left rear motor apparatus based upon movement of a control knob, a set of command signals sent from the remote-control transmitter to the receiver apparatus that includes speed and direction control commands to the right rear motor apparatus and the left rear motor apparatus, and a process wherein a loss of radio wave signal between the remote-control transmitter and receiver apparatus cuts off power to the R/C mower electric blade motors and cuts off power to the R/C mower right rear motor apparatus and of the R/C mower left rear motor apparatus.

Also in one embodiment a cutting deck as a portion of the main body includes a set of attached blade motors that may be individually raised and lowered within the cutting deck. Also in one embodiment a cutting deck as a portion of the main body may be raised and lowered by means of adjustable mechanisms between wheels or wheel motors and the cutting deck. Also in one embodiment a cutting deck is adjustably suspended from the R/C mower main body and wherein a set of blade motors are rigidly attached. Also in one embodiment the battery or batteries are the standard off-the-shelf variety that may be used in other electric home power tools such as drills and sanders. Also in one embodiment a center front swiveling caster wheel apparatus replaces the left front and right front caster wheels. Also in one embodiment the blade motor controller is replaced by a remote control solenoid switch which simply turns the blade motors on or off. Also in one embodiment the R/C mower blades, each comprise a disk with 2 to 4 razor blades firmly attached around the perimeter or the razor blades are attached to a swivel allowing each blade to spin and retract when hitting a hard surface. Also in one embodiment the R/C mower blades each comprise a flat elongated metal blade which is sharpened at both ends. Also in one embodiment the R/C mower blades each comprise a flat X shaped metal blade which is sharpened at all 4 ends. Also in one embodiment the front side of the cutting deck is open to allow grass to easily move into the cutting blades. Also in one embodiment the drive wheels are made of plastic for light weight, and have plastic or rubber spikes protruding perpendicularly to the circumference of the wheels. Also in one embodiment the remote-control transmitter includes a safety button that an operator must depress in order to maintain operation of the R/C mower cutting blades and the right rear motor apparatus and the left rear motor apparatus. Also in one embodiment various sized batteries can be used with a range of voltages and amperages. Also in one embodiment a video camera is attached to the R/C mower to send back live stream video to a video screen attached to the R/C transmitter. Also in this embodiment, the video camera may be a 360-degree video camera.

### BRIEF DESCRIPTION OF DRAWINGS

FIG. 1 shows a 24 inch embodiment of the R/C mower overall design and style. It highlights the removable batteries, main power switch, left rear and right rear drive wheels, left front and right front caster wheels, center cutting blade, cutting deck, electronics enclosure cover, and blade motor covers.

FIG. 2A shows the rear/corner view of a 24 inch embodiment of the R/C mower. It highlights the removable batteries, main power switch, left rear and right rear drive wheels, cutting deck, electronics enclosure, electronics enclosure cover, blade motor covers, and left and right rear drive motors.

FIG. 2B is the same view as FIG. 2A with the batteries removed showing the battery mounts at the rear of the R/C mower.

FIG. 3 is a right/side view of a 24 inch embodiment of the R/C mower. It highlights the right side removable battery, main power switch, right rear drive wheel, right front caster wheel, cutting deck, electronics enclosure, right blade motor cover, and carrying handle.

FIG. 4A is a top view of the R/C mower showing the location of the rechargeable batteries, the main power switch, the left rear and right rear drive wheels with spikes. It highlights the removable batteries, main power switch, left rear and right rear drive wheels, left and right rear drive motors, cutting deck, electronics enclosure cover, blade motor covers, and carrying handle.

FIG. 4B is the same view as FIG. 4A, but with the batteries removed to show the battery mounts.

FIG. 5 is a bottom view of the R/C mower showing the under side of the cutting deck. It highlights the left rear and right rear drive wheels, left and right rear drive motors, left and right rear drive motor mounts, left and right front caster wheels, cutting blades, cutting deck, and carrying handle.

FIG. 6 is a rear view of the R/C mower showing the rechargeable batteries, main power switch, left and right drive wheels with spikes, electronics enclosure, left and right blade motor covers, left and right drive motors, and left and right drive motor mounts.

FIG. 7 is a front view of the R/C mower showing the batteries, main power switch, left and right drive wheels with spikes, left and right front caster wheels, left and right blade motor covers, three blade motors, and electronics enclosure cover.

FIG. 8 is a bottom/front view which shows the center, left, and right cutting blade motor mounts.

FIG. 9 is a bottom/rear view that highlights the left wheel drive motor, the right wheel drive motor, and the left wheel drive motor mount that shows how the drive motors are attached to this embodiment of the R/C mower body.

FIG. 10A shows the location of the electronics enclosure cover.

FIG. 10B is a view with the electronics enclosure cover removed and shows a general layout of components within the electronics enclosure (wiring not shown).

FIG. 11 shows an overview of the R/C transmitter with the R/C Mower.

FIG. 12A is an overview showing the R/C mower with an onboard video camera and a video screen attached to the R/C transmitter.

FIG. 12B is a rear view showing a 360-degree video camera attached on top of the R/C mower, and also the video screen attached to the R/C transmitter.

FIG. 13A shows a close-up of the 360-degree video camera, the camera's front lens, and the camera mount bar.

FIG. 13B is a side view of the 360-degree video camera, showing the front and back lenses.

FIG. 14 shows inside the electronics enclosure to reveal the additional electronics for an onboard video camera.

FIG. 15 is the first of a series of drawings of the 36 inch embodiment of the R/C mower. It highlights the new features including a third battery, adjustable cutting deck, and deck adjustment and support apparatus.

FIG. 16 is a top/rear view of the 36 inch embodiment of the R/C mower clearly showing the three removable batteries, the adjustable cutting deck, and one of the swing arm supports.

FIG. 17 is a side view showing how the adjustable cutting deck is suspended under a 36 inch R/C mower body by means of the swing arm supports and cutting deck adjustment cables.

FIG. 18 is a top view of a 36 inch R/C mower showing the overall design of the R/C mower with the cutting deck extending out to the width of the left and right drive wheels.

FIG. 19 is a bottom view of a 36 inch R/C mower showing how the adjustable cutting deck fits between the front and rear wheels of the R/C mower. It highlights the cutting deck and the three cutting blades.

FIG. 20 shows a rear view of the R/C mower highlighting three batteries, the main power switch, the adjustable cutting deck and the deck adjustment and support apparatus.

FIG. 21 is a front view of the R/C mower showing the open front of the adjustable cutting deck and another view of the deck adjustment apparatus with the cutting deck adjustment cables.

FIG. 22 is a bottom/side view of the adjustable cutting deck and shows the center, left, and right cutting blade motors and motor mounts.

FIG. 23 shows a view of how the back of the adjustable cutting deck attaches to the R/C mower body with one of the swing arm supports.

FIG. 24 shows a top view of the R/C mower with the electronic enclosure cover removed.

FIG. 25 shows a detailed view of the inner deck adjustment apparatus including the cutting deck adjustment cables, cutting deck adjustment pulleys, and cutting deck adjustment knob.

### DETAILED DESCRIPTION

The inventor provides a unique remote control (R/C) lawn mower. The R/C mower has a unique combination of features including remote control, easy portability, zero turn capability, direct motor drive, and complete battery powered operation.

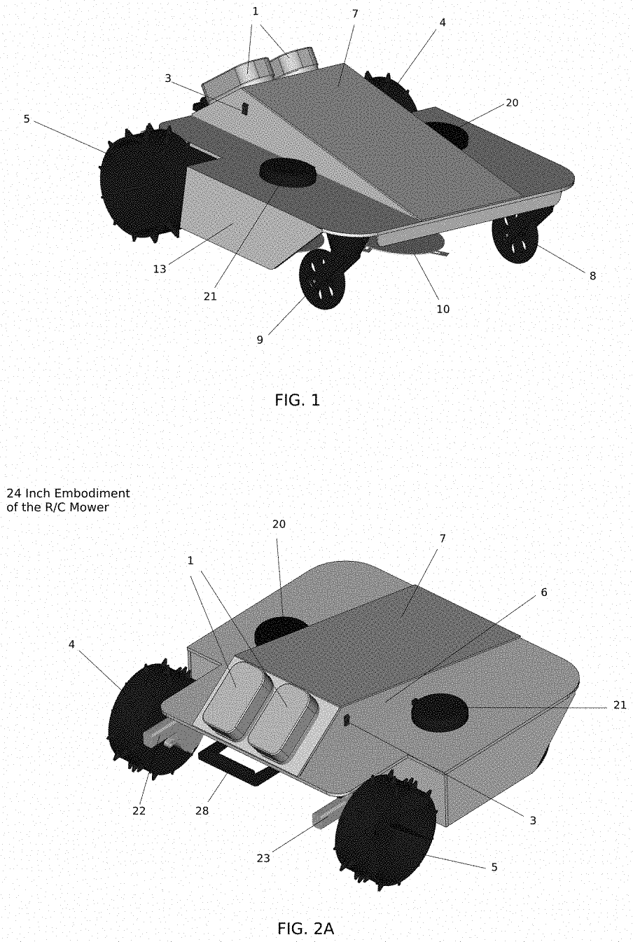

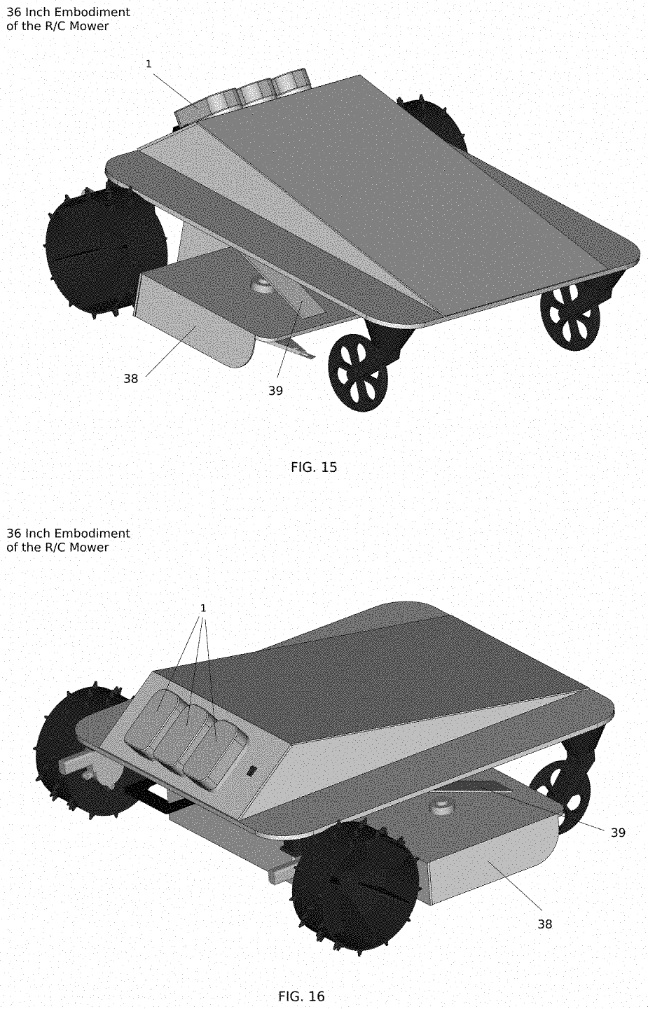

The present invention is described in enabling detail in the following examples, which may represent more than one embodiment of the present invention. This description is organized by drawings which are grouped into 2 categories. FIGS. 1 to 14 show a 24 inch embodiment of the R/C mower, and FIGS. 15 to 25 show a 36 inch embodiment of the R/C mower.

FIG. 1 shows a 24 inch embodiment of the R/C mower overall design and style. The R/C mower body is made of lightweight material such as plastic or aluminum but is of a quality to provide a rigid structure for supporting the functionality of the machine. There is no separate frame for structural support. This design keeps the R/C mower very light and easy to manage.

The R/C mower is completely electric powered. It is powered by rechargeable batteries that plug in just like with electric hand tools. A variety of battery sizes will be available so that people can choose a size to allow them to complete their entire yards before running out of power. The batteries are externally charged which allows swapping a second set of batteries without waiting for re-charging. This allows mowing extra large yards or multiple locations.

The figure shows the rechargeable batteries 1 plugged into the back of the R/C mower, the main power switch 3, the left rear drive wheel with spikes 4, the right rear drive wheel with spikes 5, the electronics enclosure cover 7, the front left caster wheel 8, the front right caster wheel 9, the center cutting blade (1 of 3 cutting blades) 10, the cutting deck 13 and the left 20 and right 21 blade motor covers. Note that this embodiment of the R/C mower has 2 front caster wheels, while smaller embodiments may have only 1 front caster wheel rotatably attached to the front center of the R/C mower body.

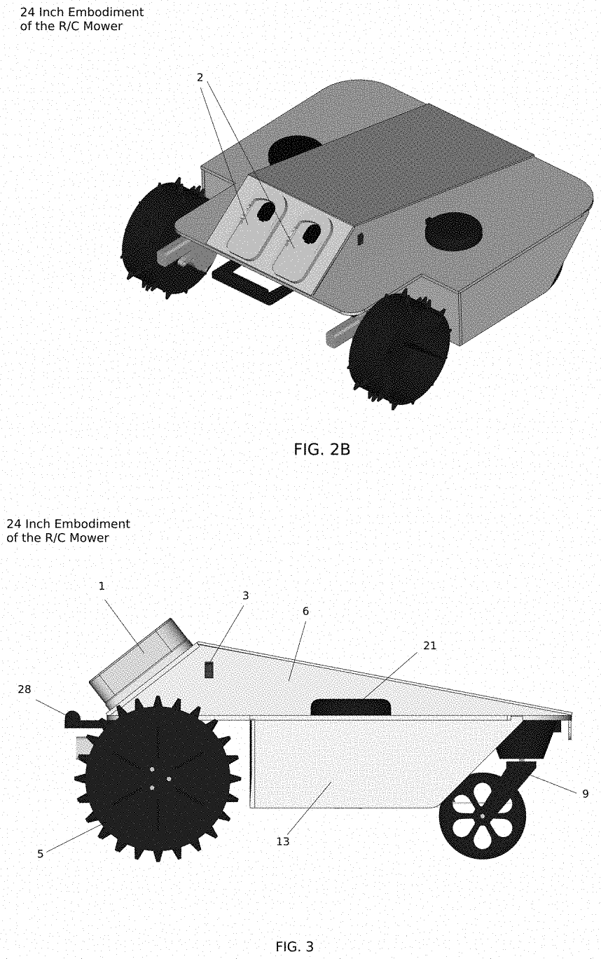

FIG. 2A shows the rear/corner view of a 24 inch embodiment of the R/C mower. The rechargeable batteries 1 are mounted on the rear of the R/C mower. The main power switch 3 is on the right side of the electronics enclosure near the batteries. This switch controls power from all batteries to all motors on the R/C mower. This view shows the left rear drive wheel with spikes 4 and the right rear drive wheel with spikes 5 at the back end of the R/C mower. These two drive wheels work together to move the R/C mower forward, backward, left or right, depending on the speed and direction of the drive motors they are attached to. This design implements the zero turn capability.

The electronics enclosure 6 keeps the all the electronic processors, communications components, and wiring clean and dry. The enclosure 6 also provides structural rigidity to the R/C mower. The electronics enclosure cover 7 covers the top of the electronics enclosure 6. The left blade motor cover 20 and right blade motor cover 21 are shown on the top of the cutting deck. The left drive motor 22, and right drive motor 23 are shown to the rear of the unit attached to the left drive wheel 4 and right drive wheel 5. These drive motors are gear motors consisting of a worm gear which turns a gear or set of gears connected directly to the axle. Also, the carrying handle 28 is shown at the rear center of the R/C mower, which allows the unit to be carried easily.

FIG. 2B is a view of a 24 inch embodiment of the R/C mower with the batteries removed showing the battery mounts 2 at the rear of the R/C mower.

FIG. 3 is a right/side view of a 24 inch embodiment of the R/C mower. The right side battery 1, is shown on the top back of the R/C mower, the main power switch is shown on the right side of the electronics enclosure, and the right drive wheel with spikes 5 is shown near the rear of the R/C mower.

The drive wheels can be made of plastic, rubber, or a combination of the two. One embodiment of that combination would be a plastic wheel as shown, but with the spikes made of rubber and attached around the circumference of the wheel. Because of the low weight of the R/C mower, the drive wheels must include large spikes to achieve the traction necessary to propel the R/C mower over outdoor terrain, especially up and down hills. The drive wheel design criteria are a balance of low weight, strength, and traction ability.

The electronics enclosure 6 comprises the top portion of the R/C mower body. The right front caster wheel 9, is shown and the cutting deck 13, is shown attached underneath the electronics enclosure 6. The right blade motor cover 21 on the top of R/C mower and the carrying handle 28 near the rear of the R/C mower are also illustrated.

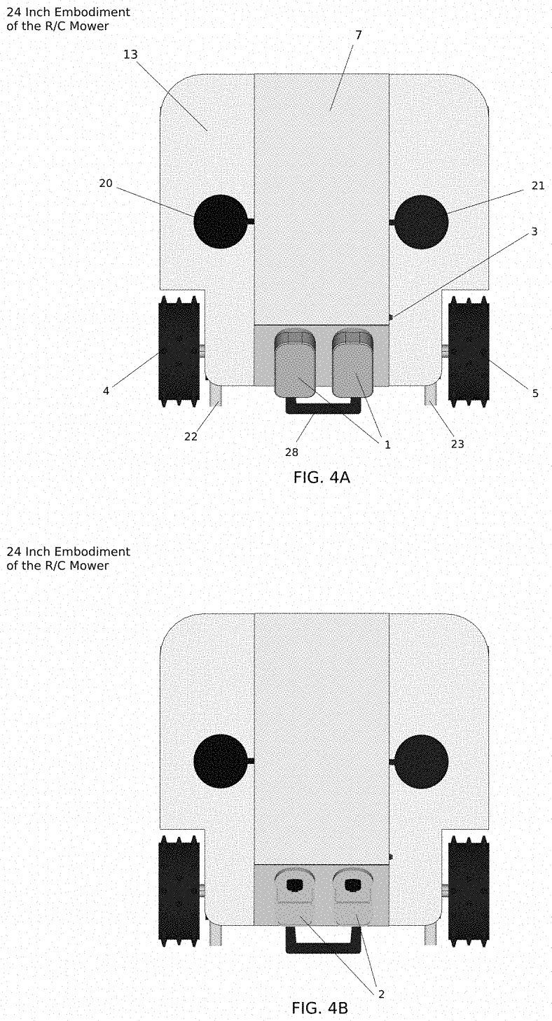

FIG. 4A is a top view of the R/C mower showing the location of the rechargeable batteries 1, the main power switch 3, the left rear drive wheel with spikes 4 and the right rear drive wheel with spikes 5. This view also shows the electronics enclosure cover 7 on top of the unit and the cutting deck 13. The left blade motor cover 20 and the right blade motor cover 21 are shown on the top of the left and right side of the cutting deck 13. The back end of the left drive motor 22, and the back end of the right drive motor 23 are seen extending out from the cutting deck 13. Finally, the figure also shows the carrying handle 28.

FIG. 4B is the same view as FIG. 4A, but with the batteries removed and showing the battery mounts 2.

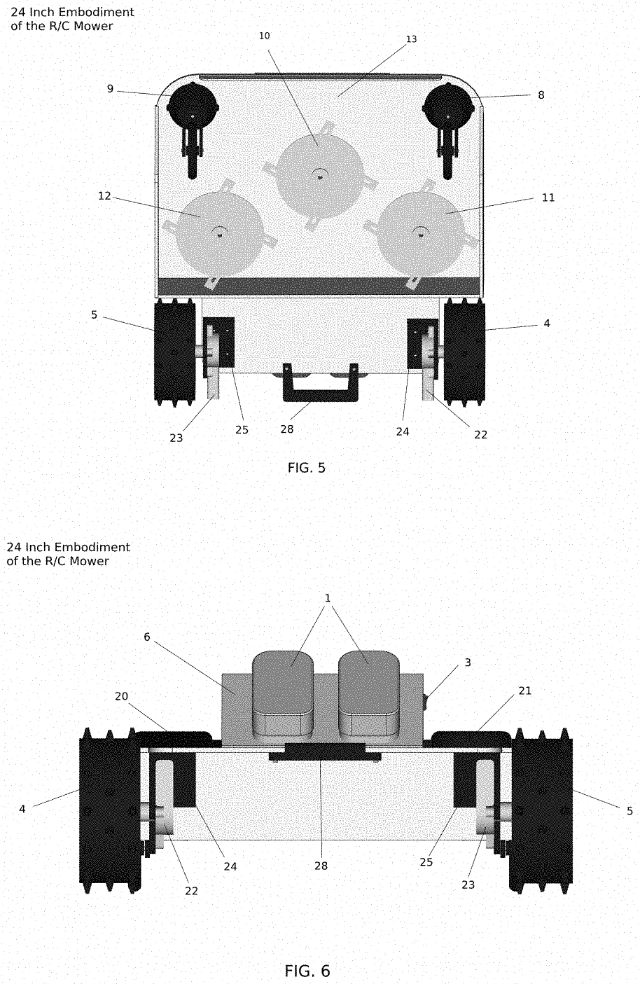

FIG. 5 is a bottom view of the R/C mower showing the under side of the cutting deck 13. Here the relationship between the left rear drive wheel 4, the left drive motor 22 and the left motor mount 25 is visible. In the same way it shows the relationship between the right rear drive wheel 5, the right drive motor 23 and the right motor mount 25. This embodiment of the motor mounts does not preclude direct attachment to the R/C mower body through a combination of various body shapes and/or various motor types. The drive motors 23 and 24 shown are a particular real world design being accommodated here by means of custom designed mounts 24 and 25.

The figure also shows the center 10, right 11 and left 12 cutting blades. The general design philosophy for the cutting blades is to keep them relatively small compared to the size of the blade motor. This allows a set of relatively small, low power/low torque electric motors to achieve high power/torque results. Higher torque enables cutting with less chance of bogging down. There can be many embodiments of this blade design, with two of them shown in this document. Grass cutting blades should be tailored to the job to be performed. The blades shown here are of the disk type with razor blades attached. Generally, the razor blades are loosely attached to a lightweight metal disk. When the disk spins at high speed, the blades extend outward from the center by means of centrifugal force. This gives efficient cutting ability but also allows retraction of the blades when an obstacle is encountered. Other cutting blades can be a thin, solid metal design, but still achieve a low weight. Note that this 24 inch embodiment of the R/C mower has three cutting blade apparatuses arranged with the center apparatus in a forward position relative to the other two apparatuses. As is common practice, this offset arrangement of the blade apparatus positions, instead of arranging them in a straight line, allows blade overlap and prevents grass from passing between any two of the blades. In other embodiments, the center blade apparatus may be in a rearward position relative to the other two blade apparatuses (e.g. the 36 inch R/C mower described later, or in the case of a single front center caster design). Also in other embodiments for larger R/C mowers, there may be more blade apparatuses mounted across the width of the R/C mower cutting deck to achieve a wider cutting path.

This figure also shows, and the left 8 and right 9 caster wheels. The caster wheels are also designed to be lightweight but strong. There can be many embodiments of these wheels regarding material used, such as plastic, metal, rubber, or a combination of the three. The caster wheels shown in the figure are made completely of plastic, except for metal screws to hold the plastic parts together. Use of metal is kept to a minimum to encourage low weight.

FIG. 6 is a rear view of the R/C mower showing the rechargeable batteries 1, the main power switch 3, the left 4 and right 5 drive wheels with spikes, the electronics enclosure 6, the left 20 and right 21 blade motor covers, the left 22 and right 23 drive motors and the left 24 and right 25 drive motor mounts. The carrying handle 28 is also shown from the back.

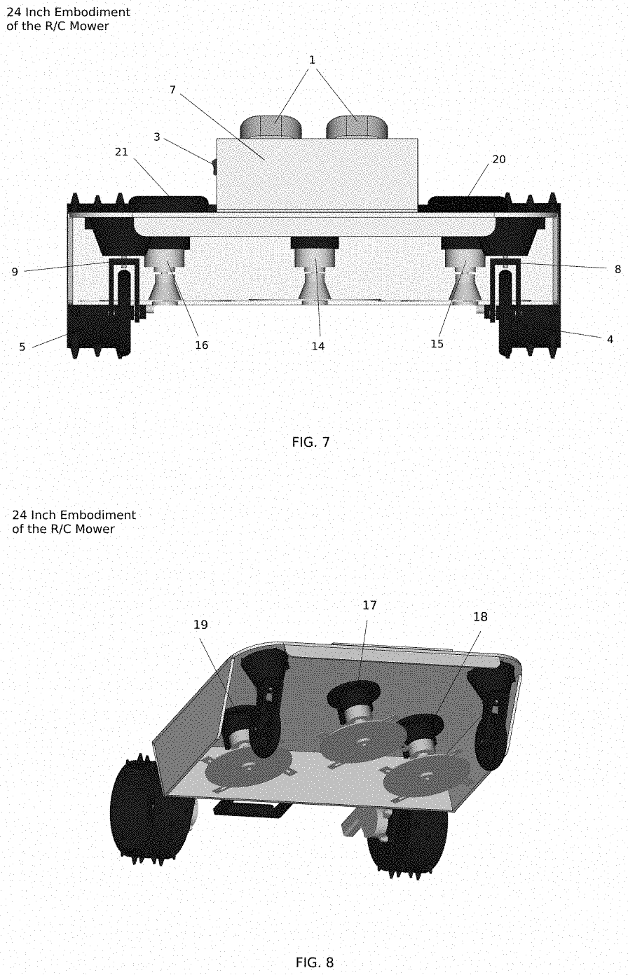

FIG. 7 is a front view of the R/C mower showing the batteries 1, main power switch 3, the left 4 and right 5 drive wheels with spikes, the left 8 and right 9 front caster wheels, and the electronics enclosure cover 7. Also shown are the left 4 and right 5 drive wheels, the center 14, left 15 and right 16 blade motors and the left 20 and right 21 motor covers.

FIG. 8 is a bottom/front view which shows the center 17, left 18, and right 19 cutting blade motor mounts. These motor mounts secure the electric motors perpendicularly to the top of the cutting deck enclosure. The motor mounts shown are but one embodiment of the method of attaching the motors to the R/C mower cutting deck. The motor mounts depicted in the figure can be loosened and re-tightened to adjust the motors up and down for a longer or shorter grass length respectively. Other embodiments included a rack-and-pinion design for enabling adjustment by the turning of a knob, motor mounts built into the cutting deck itself, or simple clamp mounts (as will be shown in the 36 inch embodiment of the R/C lawn mower).

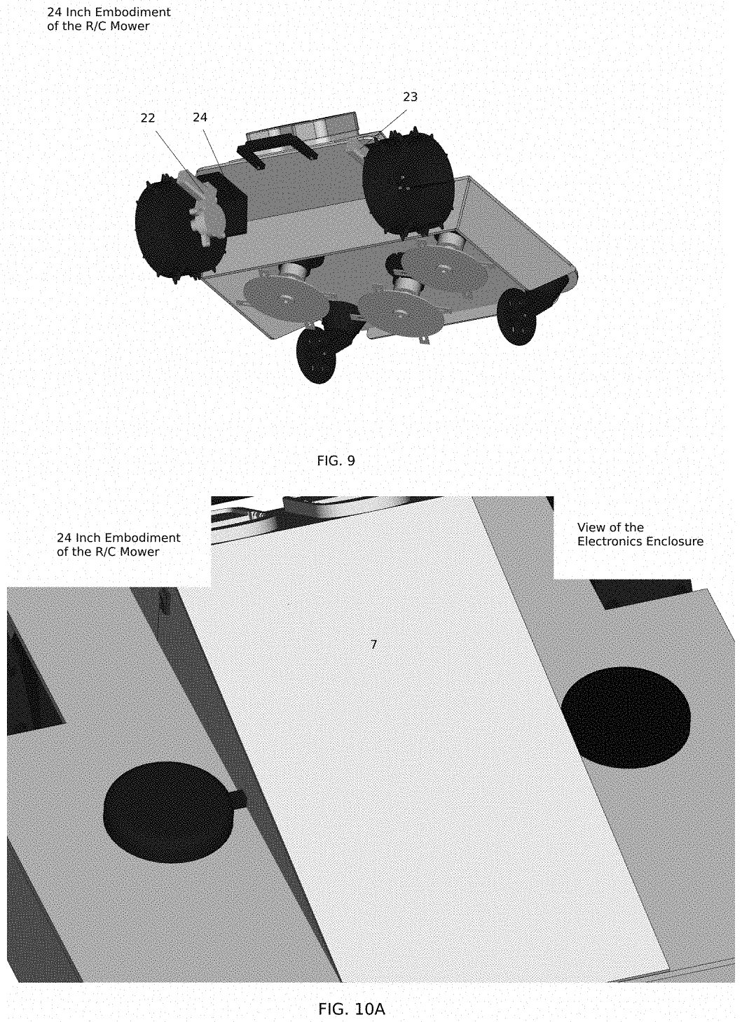

FIG. 9 is a bottom/rear view that highlights the left wheel drive motor 22, the right wheel drive motor 23, and the left wheel drive motor mount 24 that shows how the drive motors are attached to this embodiment of the R/C mower body.

FIG. 10A shows the location of the electronics enclosure cover 7. This cover is removable to perform any maintenance or upgrades to the R/C mower as desired.

FIG. 10B is a view with the electronics enclosure cover 7 removed and shows a general layout of components within the electronics enclosure 6 (wiring not shown). The blade motor controller 26, wheel motor controller 27, the radio control (R/C) receiver 29 and the top of the center blade motor 14 can also be seen.

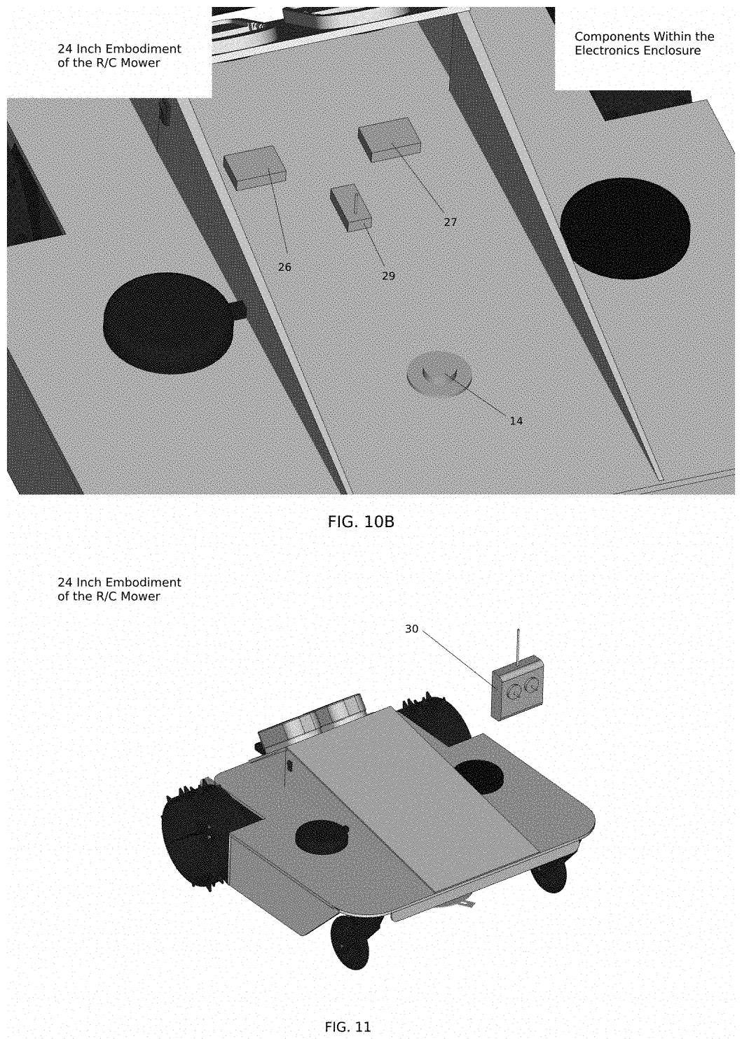

FIG. 11 shows an overview of the R/C Mower with the R/C transmitter 30. The transmitter 30 comprises a hand-held device (typically 3-channel), which sends three radio signals to the R/C mower, one to each drive motor for steering and speed control, and the third channel to the blade motors. A program and microchip in the transmitter 30 translates direction control from a knob or joystick into independent signals to each wheel's drive motor. The transmitter 30 is held by the operator who stands or sits somewhere comfortable in the direct view of the area being mowed. The R/C transmitter 30 can be of the general commercial-off-the-shelf variety for remote control planes/drones, or can be a custom designed device made specifically for the R/C mower.

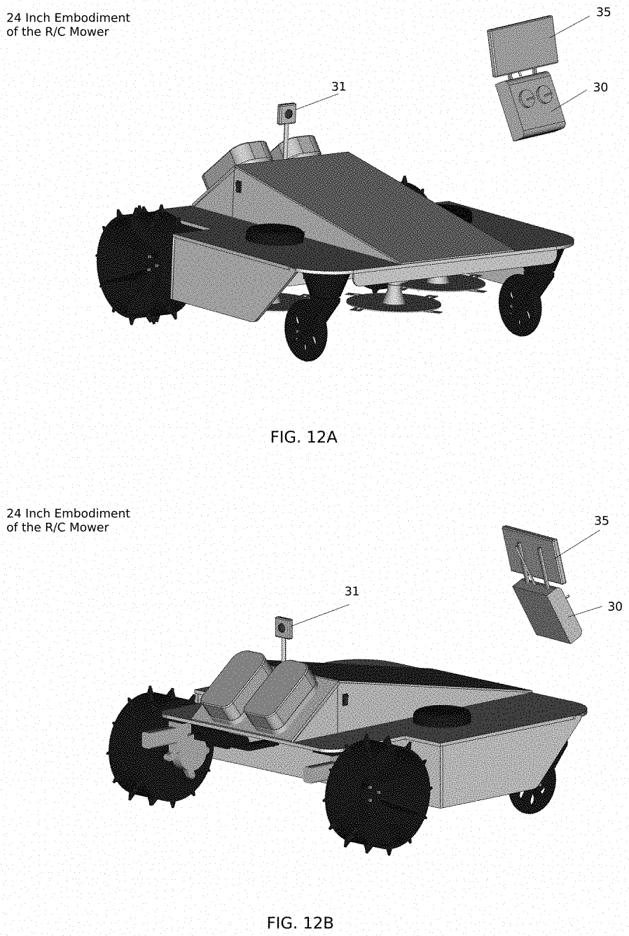

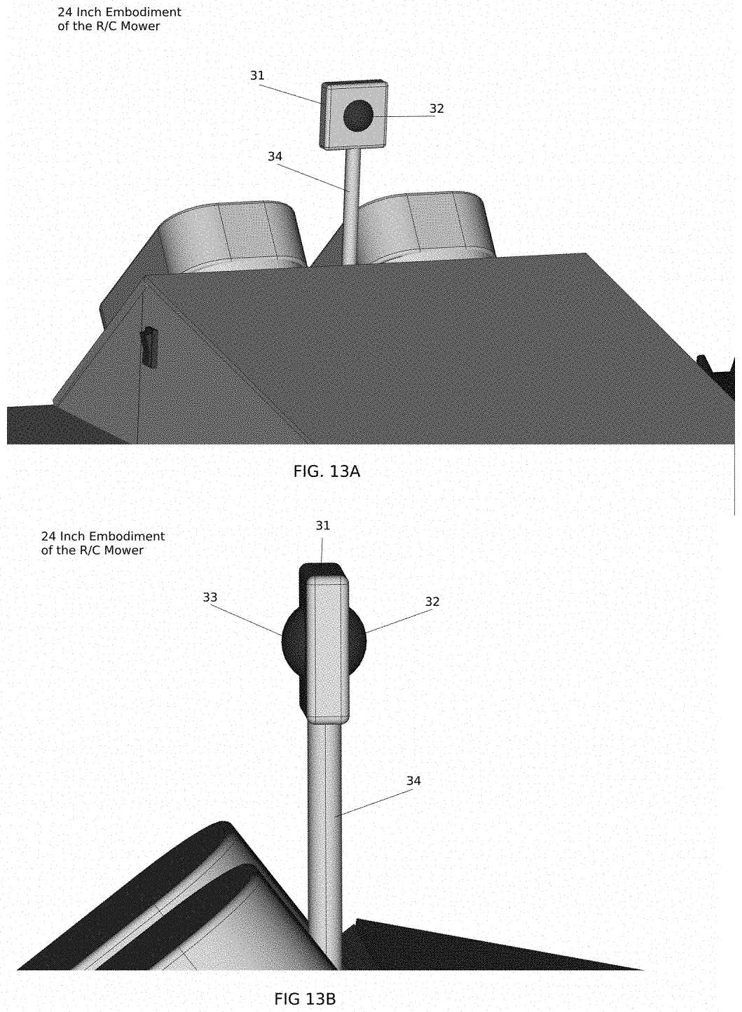

FIG. 12A is an overview showing the R/C mower with an onboard video camera. This embodiment shows a 360-degree video camera 31 and also the video screen 35 attached to the R/C transmitter 30. This embodiment of the R/C mower removes the requirement to be in direct view of the area being mowed. The camera 31 is attached to the R/C mower facing in a forward direction and connected to a video transmitter which streams live video from the R/C mower to the video screen 35 attached to the R/C hand-held transmitter 30. This equipment allows the operator of the R/C mower to be anywhere within range of the R/C mower radio signals. That includes being inside a house or building. The camera 31 is a 360-degree model, allowing the operator to see a 360 degree view around the R/C mower. Other embodiments of the camera can be standard or wide angle view cameras that look only in the forward direction. The choice of camera will be according to the specific job to be performed.

FIG. 12B is a rear view showing a 360-degree video camera 31 attached on top of the R/C mower, and also the video screen 35 attached to the R/C transmitter 30.

FIG. 13A shows a close-up of the 360-degree video camera 31, the camera's front lens 32, and the camera mount bar 34.

FIG. 13B is a side view of the 360-degree video camera 31, showing the front and back lenses. Visible, are the camera 31, the camera's front lens 32, the camera's rear lens 33 and the camera mount bar 34. The two lenses combine to give a complete 360 view of the R/C mower's surroundings. This is useful not only for seeing the grass to be mowed, but also for seeing who or what is in proximity to the R/C mower.

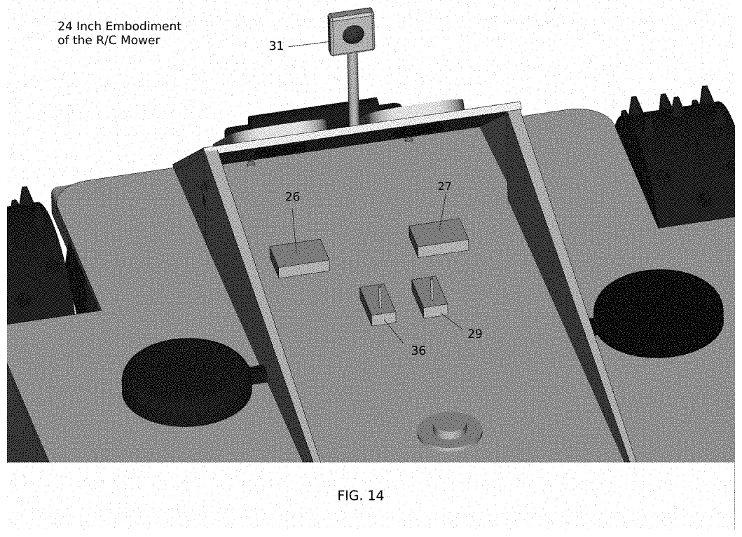

FIG. 14 shows the electronics enclosure with the cover removed to reveal the additional electronics for an onboard video camera. The 360-degree video camera 31, the blade motor controller 26, the wheel motor controller 27, the radio control (R/C) receiver 29 and the camera video transmitter 36.

FIG. 15 is the first of a series of drawings of the 36 inch embodiment of the R/C mower. This embodiment includes all of the components of the 24 inch R/C mower but in a larger size. Additional features include an adjustable cutting deck 38 that can be raised and lowered, a deck adjustment and support apparatus (shown partially) 39 and a third battery 1 for extra power FIG. 16 is a top/rear view of the 36 inch embodiment of the R/C mower clearly showing the three removable batteries 1, the adjustable cutting deck 38, and one of the swing arm supports 39.

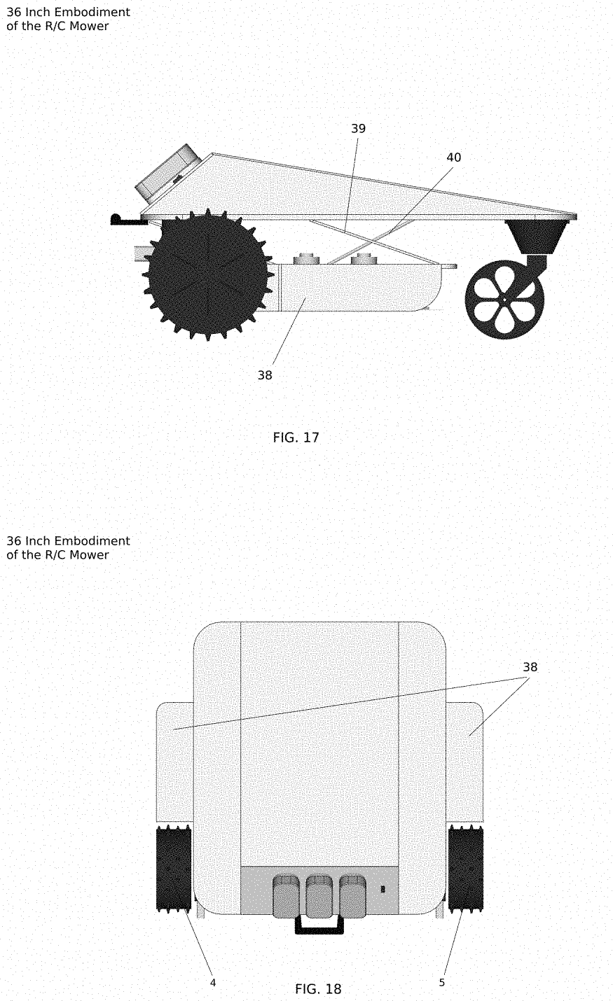

FIG. 17 is a side view showing how the adjustable cutting deck 38 is suspended under a 36 inch R/C mower body by means of the swing arm supports 39 and cutting deck adjustment cables 40. The swing arms are made of lightweight but structurally rigid material capable of supporting the weight of the cutting deck 38. Each swing arm consists of a bar or elongated plate with hinges at both ends. The hinges are attached to the bottom of the mower body on one end and to the top of the cutting deck on the other end. The swing arms are attached in such a way as to allow the mower deck to swing up and forward while keeping a horizontal orientation. The cables 40, extend from the front of the R/C mower body down to the rear of the cutting deck 38 in such a manner as to lift the cutting deck 38 up and forward when they are tightened.

FIG. 18 is a top view of a 36 inch R/C mower showing the overall design of the R/C mower with the cutting deck 38 extending out to the width of the left 4 and right 5 drive wheels. This keeps the drive wheels 4, 5 always operating in the path of previously cut grass. This design has two benefits. The first is that the grass is not pressed down by the drive wheels 4, 5 before moving into the cutting blades. Only the thin front caster wheels come into contact with the grass before cutting. The second benefit of this design is that the drive wheels 4, 5 have better contact with the ground after when grass is already cut. This cutting deck design in relation to the drive wheels 4, 5 is a feature of all embodiments of the R/C mower.

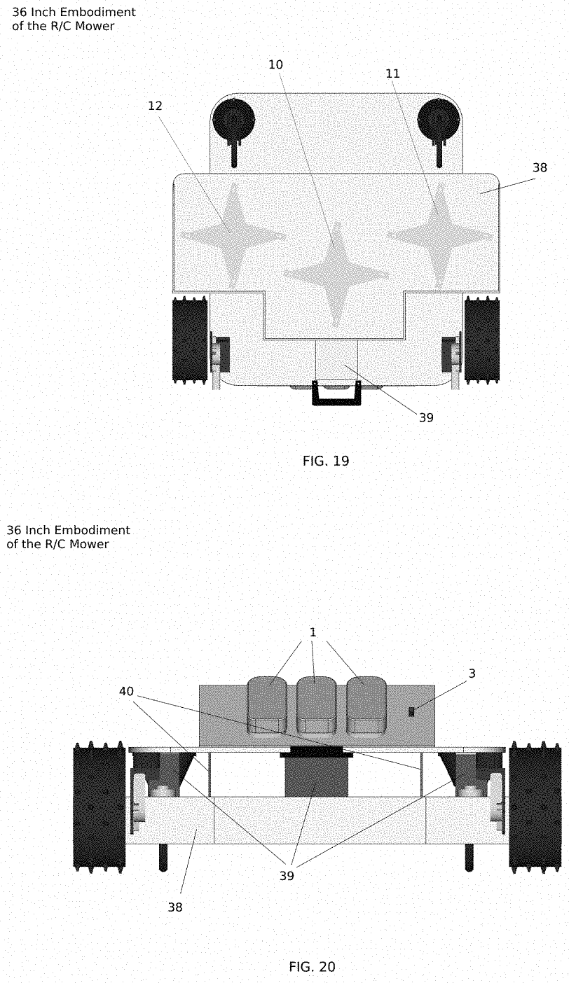

FIG. 19 is a bottom view of a 36 inch R/C mower showing how the adjustable cutting deck 38 fits between the front and rear wheels of the R/C mower. Toward the rear of the R/C mower body is the rear swing arm of the deck adjustment and support apparatus 39. In this embodiment, the deck 38 has 3 blade apparatuses attached with the center blade apparatus offset to the rear of the deck. The cutting blades 10, 11, 12, are of a different design than the ones shown for the 24 inch embodiment of the R/C mower (FIG. 5). These blades are larger and each have 4 cutting arms, each with an attached razor blade mounted at the end. With the possible difference of being larger, all of the other mower components visible in this figure are the same as in the 24 in embodiment of the R/C mower.

FIG. 20 shows a rear view of the R/C mower highlighting the adjustable cutting deck 38 and the deck adjustment and support apparatus 39 and 40. It also show the location of the three removable batteries 1, and the main power switch 3. All three of the swing arms 39 are visible. Both of the adjustment cables 40 are also visible. The swing arms 39 are attached by hinge towards the back of the R/C mower body and slope down toward the front of the cutting deck 38 where they are all attached by hinge also. The three attachment points give a balanced and stable connection to the cutting deck 38. The adjustment cables 40 extend out from the front of the mower body and slope down and back towards the back of the cutting deck 38. This angle allows the adjustment cables 40 to be tightened to pull the cutting deck upwards for a longer grass length. Loosening the adjustment cables 40 allows the cutting deck 38 to fall down lower due to gravity, producing a shorter grass length.

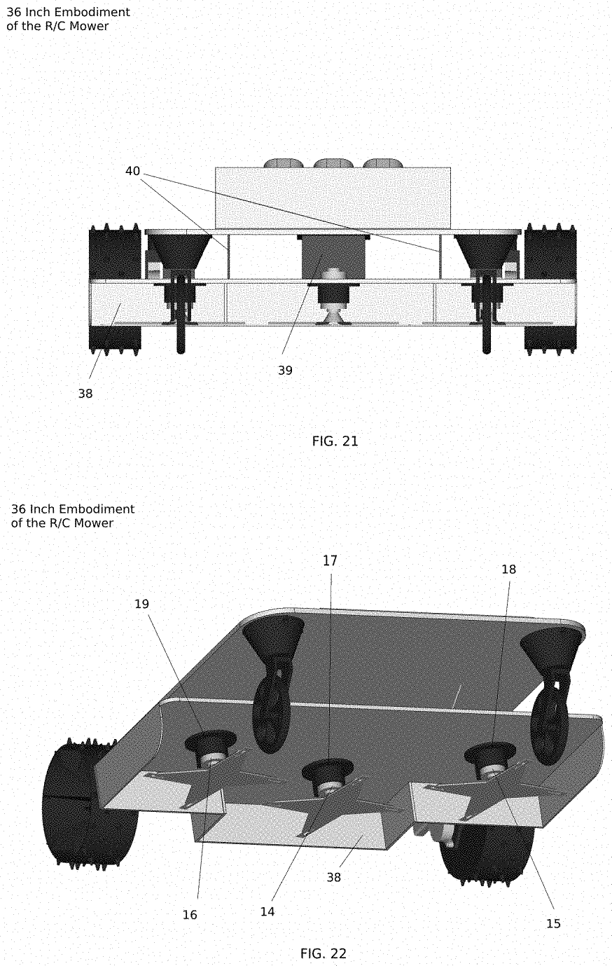

FIG. 21 is a front view of the R/C mower showing the open front of the adjustable cutting deck 38 and another view of the deck adjustment apparatus 39, 40.

FIG. 22 is a bottom/side view of the adjustable cutting deck 38 and shows the center 17, left 18, and right 19 cutting blade motor mounts. Also shown are the center 14, left 15 and right 16 blade motors. As stated before this is only one embodiment of the mounting possibilities for connecting the blade motors to the cutting deck 38.

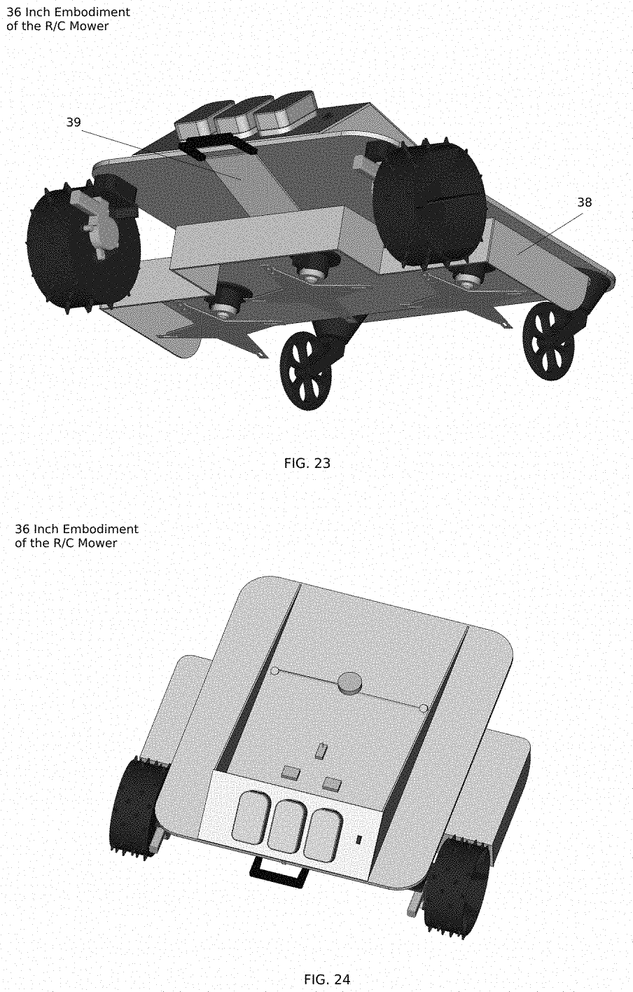

FIG. 23 shows a view of how the back of the adjustable cutting deck 38 attaches to the R/C mower body with one of the swing arm supports 39. This center swing arm support is extra wide to give lateral stability to the cutting deck 38. This means the cutting deck 38 will be less prone to swinging from side to side.

FIG. 24 shows a top view of the R/C mower with the electronic enclosure cover 7 removed. It shows the general location of the electronics (wiring not shown) and of the inner part of the deck adjustment apparatus.

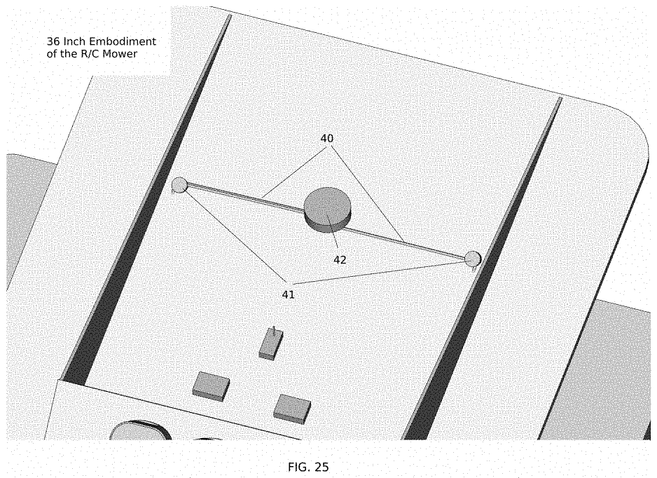

FIG. 25 shows a detailed view of the inner deck adjustment apparatus including the cutting deck adjustment cables 40, cutting deck adjustment pulleys 41, and cutting deck adjustment knob 42. The cutting deck adjustment cables 40 are attached to the adjustable cutting deck 38 on the left and right sides and pass up through the R/C mower body and around the cutting deck adjustment pulleys 41 and then to the center of the R/C mower body where they are wound around the cutting deck adjustment knob 42. The knob 42 is rotated clockwise to raise the cutting deck 38, and rotated counter-clockwise to lower the cutting deck.

It will be apparent to the skilled artisan that the embodiments described above are specific examples of a single broader invention which may have greater scope than any of the singular descriptions taught. There may be many alterations made in the descriptions without departing from the spirit and scope of the present invention.

The invention claimed is:

1. A portable, remote control, zero turn, electric, direct drive, lawn mower (aka. R/C mower) comprising:
a cutting deck as part of the main body for attaching and enclosing the cutting blades and also providing the main supporting structure for the R/C mower;
an electronics enclosure as part of the main body and attached to the cutting deck containing all microprocessors and communications devices required and also providing the additional supporting structure for the R/C mower;
a hand-held, remote-control transmitter that sends a set of command signals to a receiver apparatus on the R/C mower;
a handle attached to the rear of the main body of the R/C mower to allow easy carrying;
a right rear motor apparatus rigidly attached to the main body for propelling the right rear wheel through the use of a rotatable shaft from the rear right motor to the wheel;
a left rear motor apparatus rigidly attached to the main body for propelling the left rear wheel through the use of a rotatable shaft from the left wheel motor to the wheel;
a right front mounted free swiveling caster wheel apparatus rotatably attached to the body;
a left front mounted free swiveling caster wheel apparatus rotatably attached to the body;
one or more rotating electric motors firmly or adjustably mounted to a cutting deck;
each of one or more grass cutting blades connected to a rotating drive shaft of one of a rotating motor;
one or more rechargeable batteries for storing the electric power and driving the motors;
one or more battery mounting plates firmly attached to the R/C mower main body;
a main power switch incorporating a lighted element indicating when lit, that the R/C mower is on;
one dual-motor controller to regulate the amount of current flowing to the left wheel motor and right wheel motor;
a separate motor controller to regulate the amount of current flowing to the blade motors;
a microprocessor and software control system on the transmitter that wirelessly send the set of command signals to the receiver which processes the signals and sends appropriate commands to the motor controllers, which then send electric power to the right rear motor apparatus and the left rear motor apparatus based upon movement of a control knob;
a set of command signals sent from the remote-control transmitter to the receiver apparatus that includes speed and direction control commands to the right rear motor apparatus and the left rear motor apparatus; and
a process wherein a loss of radio wave signal between the remote-control transmitter and receiver apparatus cuts off power to the R/C mower electric blade motors and cuts off power to the R/C mower right rear motor apparatus and of the R/C mower left rear motor apparatus;

2. The R/C mower of claim 1, wherein a cutting deck as a portion of the main body includes a set of attached blade motors that may be individually raised and lowered within the cutting deck;

3. The R/C mower of claim 1, wherein a cutting deck is adjustably suspended from the R/C mower main body and wherein a set of blade motors are rigidly attached;

4. The R/C mower of claim 1, wherein the battery or batteries are the standard off-the-shelf variety that may be used in other electric home power tools such as drills and sanders;

5. The R/C mower of claim 1, wherein a center front swiveling caster wheel apparatus replaces the left front and right front caster wheels;

6. The R/C mower of claim 1, wherein the blade motor controller is replaced by a remote control solenoid switch which simply turns the blade motors on or off;

7. The R/C mower of claim 1, wherein the R/C mower blades, each comprise a disk with 2 to 4 razor blades firmly attached around the perimeter;

8. The R/C mower blade of claim 7, wherein the 2 to 4 razor blades are attached to a swivel allowing each blade to spin and retract when hitting a hard surface;

9. The R/C mower of claim 1, wherein the R/C mower blades each comprise a flat elongated metal blade which is sharpened at both ends;

10. The R/C mower of claim 1, wherein the R/C mower blades each comprise a flat X shaped metal blade which is sharpened at all 4 ends;

11. The R/C mower of claim 1, wherein the front side of the cutting deck is open to allow grass to easily move into the cutting blades;

12. The R/C mower of claim 1, wherein the drive wheels are made of plastic for light weight, and have plastic spikes protruding perpendicularly to the circumference of the wheels;

13. The R/C mower drive wheels of claim 12, wherein the plastic spikes are replaced by rubber spikes;

14. The R/C mower of claim 1, wherein the remote-control transmitter includes a safety button that an operator must depress in order to maintain operation of the R/C mower cutting blades and the right rear motor apparatus and the left rear motor apparatus;

15. The R/C mower of claim 1, wherein various sized batteries can be used with a range of voltages and amperages;

16. The R/C mower of claim 1, wherein a video camera is attached to the R/C mower to send back live stream video to a video screen attached to the R/C transmitter;

17. The video camera of claim 16, wherein the camera is a 360-degree video camera;
